(19) United States
(12) Patent Application Publication
(10) Pub. No.: US 2019/0077600 A1
(43) Pub. Date: Mar. 14, 2019

(54) Systems and Methods for Yard Management at Distribution Centers

(71) Applicant: Walmart Apollo, LLC, Bentonville, AR (US)

(72) Inventors: Zachary Watts, Red Bluff, CA (US); John S. Meredith, Bentonville, AR (US); Andrew B. Millhouse, Gilbert, AZ (US); Jacob R. Schrader, Sterling, IL (US)

(21) Appl. No.: 16/127,668

(22) Filed: Sep. 11, 2018

Related U.S. Application Data
(60) Provisional application No. 62/557,422, filed on Sep. 12, 2017.

(51) Int. Cl. B65G 1/137

(52) U.S. Cl. CPC B65G 1/1373

(57) ABSTRACT

A system for the autonomous assignment and transport of a trailer to a receiving door in a distribution center is disclosed. A server receives details about the freight of a trailer from a third party. The characteristics of the freight are categorized and weighted based on the mapping of freight characteristics against the characteristics of each of the receiving doors of a distribution center. A suitability score for the door is determined based on a comparison of the characteristics of each. The system selects a door based on the suitability score and directs an autonomous yard vehicle to locate, retrieve, and deliver the trailer to the selected door for processing.

### CROSS-REFERENCE TO RELATED PATENT APPLICATION

This application claims priority to U.S. Provisional Application 62/557,422 filed on Sep. 12, 2017, the content of which is hereby incorporated by reference in its entirety.

### BACKGROUND

Yard management systems (YMS) allocate and facilitate the movement of goods in containers from exterior trailer yards to warehouse doors and docks.

### BRIEF DESCRIPTION OF DRAWINGS

Illustrative embodiments are shown by way of example in the accompanying drawings and should not be considered as a limitation of the present disclosure.

FIG. 1 is a block diagram illustrating a system for the deployment of an autonomous yard vehicle at a distribution center according to an exemplary embodiment.

FIG. 2A is a block diagram illustrating the components of an autonomous yard vehicle according to various embodiments of the present disclosure.

FIG. 2B illustrates a cutaway top view of an autonomous yard vehicle according to various embodiments of the present disclosure.

FIG. 2C illustrates a top view of an autonomous yard vehicle according to various embodiments of the present disclosure.

FIG. 2D illustrates a bottom view of an autonomous yard vehicle according to various embodiments of the present disclosure.

FIG. 2E illustrates a side view of an autonomous yard vehicle according to various embodiments of the present disclosure.

FIGS. 3A and 3B illustrate side views of the autonomous yard vehicle coupled with a trailer according to various embodiments of the present disclosure.

FIG. 3C illustrates a top view of the autonomous yard vehicle coupled with the trailer according to various embodiments of the present disclosure

FIG. 4 is a flowchart illustrating and describing a process of selecting a distribution center dock and dispatching an autonomous yard vehicle according to an exemplary embodiment.

FIG. 5 is a flowchart illustrating and describing a process of selecting a distribution center dock according to an exemplary embodiment

FIG. 6A is a table illustrating a database format describing a trailer according to an exemplary embodiment.

FIG. 6B is a table illustrating a database format describing a delivery to a distribution center according to an exemplary embodiment.

FIG. 6C is a table illustrating a database format describing a module according to an exemplary embodiment.

FIG. 6D is a table illustrating a database format describing a door according to an exemplary embodiment.

FIG. 6E is a table illustrating a relationship between the database format supporting the matching of a delivery to a distribution center door according to an exemplary embodiment.

FIG. 7 is a block diagram illustrating an exemplary computing device suitable for use in an exemplary embodiment.

### DETAILED DESCRIPTION

Described in detail herein are systems and methods for yard management at distribution centers. Embodiments of the present disclosure can provide for dispatching autonomous yard vehicles to collect trailers and to deliver the trailers to dock doors at the distribution centers. The dock doors can be selected based on the contents of the trailers and the suitability of the doors to handle the contents of the trailers.

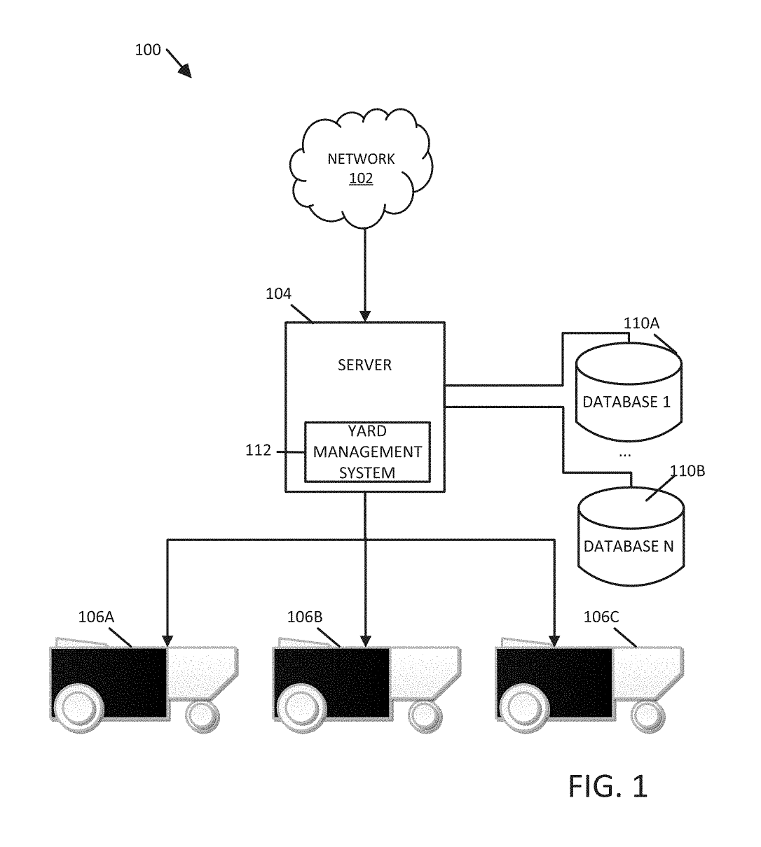

FIG. 1 is a block diagram illustrating a system 100 for yard management at a distribution center. The system 100 can facilitate the deployment of autonomous yard vehicles 106A-C to distribution center docks according to an exemplary embodiment. The system 100 can include a server 104. The server 104 can received and transmit information related to the deployment of the one or more autonomous yard vehicles 106A, 106B, 106C. The server 104 may receive information including the contents of a delivery in a trailer. The information can take the form of an advance shipment notification (ASN) which details the contents and packaging details of the trailer prior to arrival at the distribution center. The ASN can be received over network 102. In an embodiment, the network 102 can take the form of the Internet and the ASN can be transmitted from the shipper to the server 104. The reception of the ASN by the server can be facilitated by telecommunication networks implemented on but not limited to protocols stacks such as TCP/IP and LTE. Alternatively, the network 102 can be a corporate intranet.

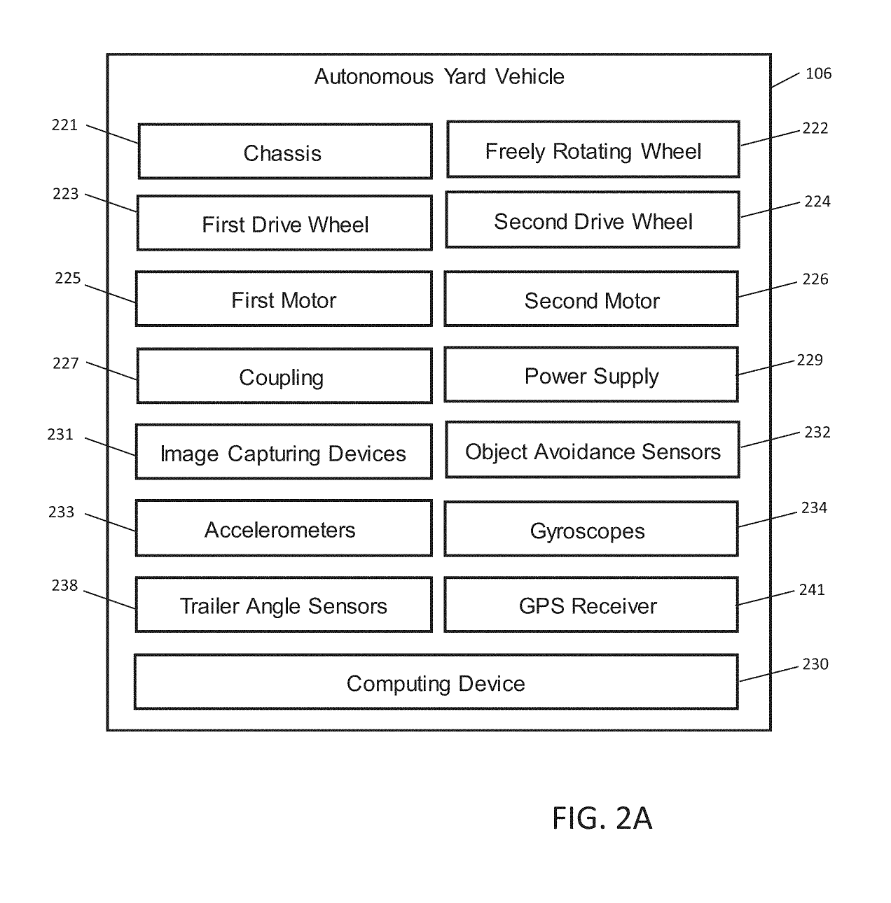

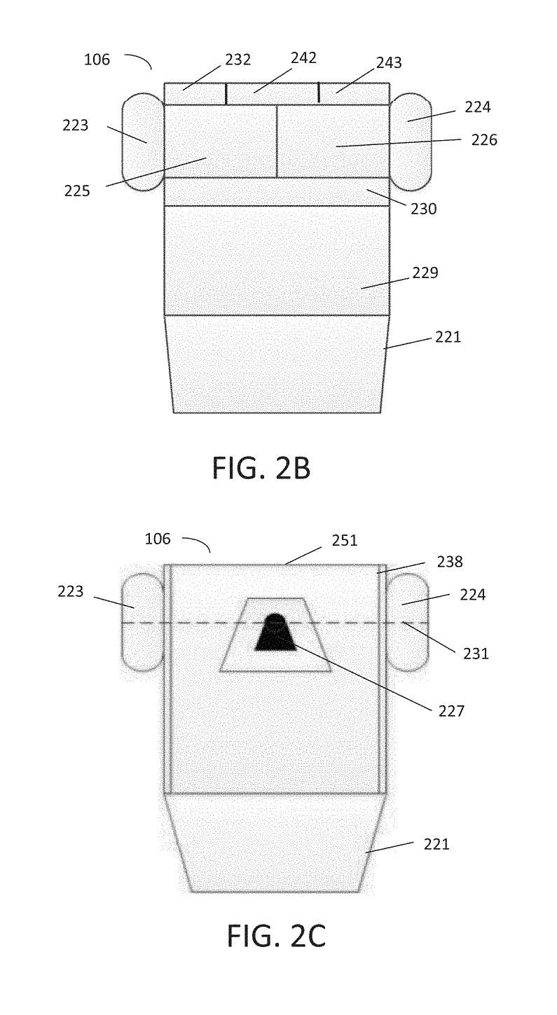

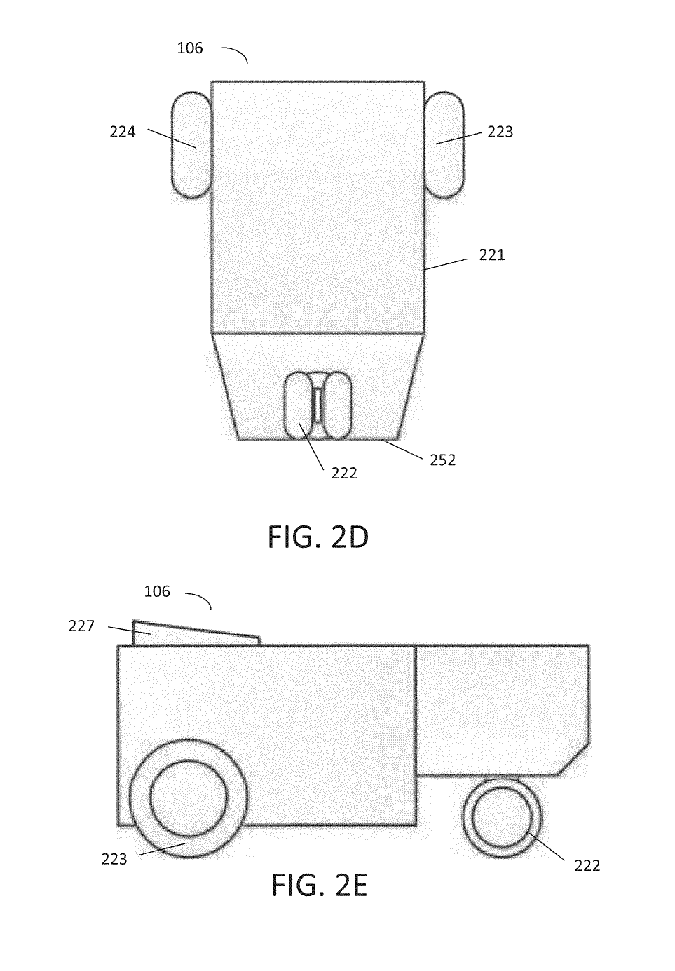

The server 104 can support logic for selecting distribution center doors based on the contents of trailers identified in the ASNs. The server 104 can select and command an autonomous yard vehicle to navigate to a location at which a selected trailer is parked, mechanically couple to the selected trailer, and deliver the selected trailer to a specific distribution center door. An exemplary embodiment of the autonomous yard vehicle is described in more detail with reference to FIGS. 2A-D and 3A-C.

The server 104 can process the ASNs received via the network 102 and can retrieve a list of characteristics pertaining to the docks and doors at a distribution center. Additionally, the server 104 can query the state of occupancy of each of the docks and doors in the distribution center. The server 104 can include logic to utilize the information from the ASNs, the characteristics of the docks and doors, and the occupancies to determine the most appropriate dock and door at which a selected trailer should be unloaded or loaded. The server 104 can also accept reservations for trailers to predetermined doors and docks. The server 104 can execute a yard management system 112. The yard management system 112 can facilitate operations pertaining to the activities associated with managing the interface between a distribution center yard and the distribution center.

In exemplary embodiments, the system can include one or more databases 110A, 110B. The databases 110A, 110B can contain information relevant to the trailers, the distribution center, and the autonomous yard vehicles. The databases 110A, 110B can include information about the trailers including the contents of the trailers, as well as the packaging method used to load the contents on the trailers. The databases 110A, 110B can include information about the distribution center doors including dock positioning, physical locations in the distribution center, and unloading hardware available at the doors. The databases 110A, 110B can include information about the autonomous yard vehicles including current tasking and locations within the yard of the distribution center.

In one embodiment, when a trailer in the distribution center needs to be moved to a particular location, such as a door or a dock, an instruction to move the trailer can be sent from the server 104 to the autonomous yard vehicle 106. In response to receiving the instruction, the autonomous yard vehicle 106 can generate a route of navigating the autonomous yard vehicle 106 to the location of the trailer 202 according to a map of the distribution center indicating the locations of the autonomous yard vehicle 106 and the trailer 202. The route is also generated according to detection results from the sensors which indicate objects around the autonomous yard vehicle 106.

As shown in FIG. 2A, the autonomous yard vehicle 106 includes a chassis 221, one or more freely rotating wheels 222, two drive wheels 223, 224, two motors 225, 226 that drive the drive wheels 223, 224 respectively, a coupling component 227 that can be coupled to the trailer, power supply 229, and a computing device 230. The autonomous yard vehicle 106 also includes image capturing devices 231, object avoidance sensors 232, accelerometers 233, gyroscopes 234, trailer angle sensors 238, and GPS receiver 241, etc.

The image capturing devices 231, such as cameras, can be associated with the autonomous yard vehicle 106 to capture images of the environment surrounding the vehicle. For example, the image capturing devices 231 can capture an image of a trailer number and extract text from the captured image, such that the autonomous vehicle can identify the trailer to be moved. Alternatively, the autonomous vehicle can includes a barcode scanner or RFID reader to identify the trailer number by reading a barcode or an RFID associated with the trailers.

The object avoidance sensors 232 can detect other objects when the autonomous yard vehicle 106 is moving in the yard. The accelerometers 233 can be used in the autonomous yard vehicle 106 to measure acceleration forces. The gyroscopes 234 can be used to provide stability or maintain a reference direction for navigating the autonomous yard vehicle 106. The trailer angle sensors 238 can detect the angle between the autonomous yard vehicle 106 and the trailer. The GPS receiver 241 determines a geographic location of the autonomous yard vehicle 106.

In one embodiment, the computing device 230 can be coupled to the autonomous yard vehicle system 106 and equipped with a processor and communication interface. The computing device 230 can receive instructions for assigning the autonomous yard vehicle 106 from the server 104, and drive the wheels 223, 224 to navigate to the location instructed by the server 104 based on the geographic location determined by the GPS receiver 241 and the detection results of the object avoidance sensors 232 and trailer angle sensors 238

FIG. 2B illustrates a cutaway top view of an autonomous yard vehicle 106 in accordance with embodiments of the present disclosure. The autonomous yard vehicle 106 includes the chassis 221, as well as the first motor 225 and the second motor 226, which are supported by the chassis 221. A first drive wheel 223 can be driven by the first motor 225, and a second drive wheel 224 can be driven by the second motor 226 such that the first and second drive wheels 223, 224 are driven independent of each other. The first and second drive motors 225, 226 can drive the first and second drive wheels 223, 224, respectively, at various speeds and torques. The first and second drive wheels 223, 224 can be driven at the same speed and torque or at different speeds and torques. In one embodiment, the first drive wheel 223 can be drive at a first speed that is different from a second speed at which the second drive wheel 224 is driven. For example, when the autonomous vehicle is turning, the outside wheel can be driven at a speed faster than the inside wheel to facilitate turning of autonomous yard vehicle and cause less wear on the tires.

The autonomous yard vehicle 106 also includes the power supply 229 that supplies energy to the components of the autonomous yard vehicle 220. For example, the power supply 229 can include batteries, hydrogen cell, a diesel generator, energy harvesting devices (e.g., solar cells), etc.

The object avoidance sensors 232 can be disposed about the chassis to detect a position of the chassis 221 relative to objects in the environment surrounding the autonomous yard vehicle 106. For example, the object avoidance sensors 232 can detect the trailers around the autonomous yard vehicle 106. In one embodiment, the object avoidance sensors 232 can be disposed on at least one side of the chassis 221. For example, as shown in FIG. 2B, the object avoidance sensors 232 are disposed adjacent to the first and second drive motors 125, 126 or the first and second drive wheels 223, 224. In an another embodiment, other accessories of the vehicle, such as vehicle lights 242 and antennas 243, etc., can be disposed adjacent to the object avoidance sensors 232.

The autonomous yard vehicle 106 further includes a computing system 230 operative coupled to the first and second drive motors 225, 226 and the object avoidance sensors 232. For example, the computing system 230 can include an onboard computer. The computing system 230 can be programmed to drive the first and second drive wheels 223, 224, via the first and second motors 225, 226, in response to outputs of the object avoidance sensors 232 to navigate to the trailer and guide the coupling between the autonomous yard vehicle system and the trailer.

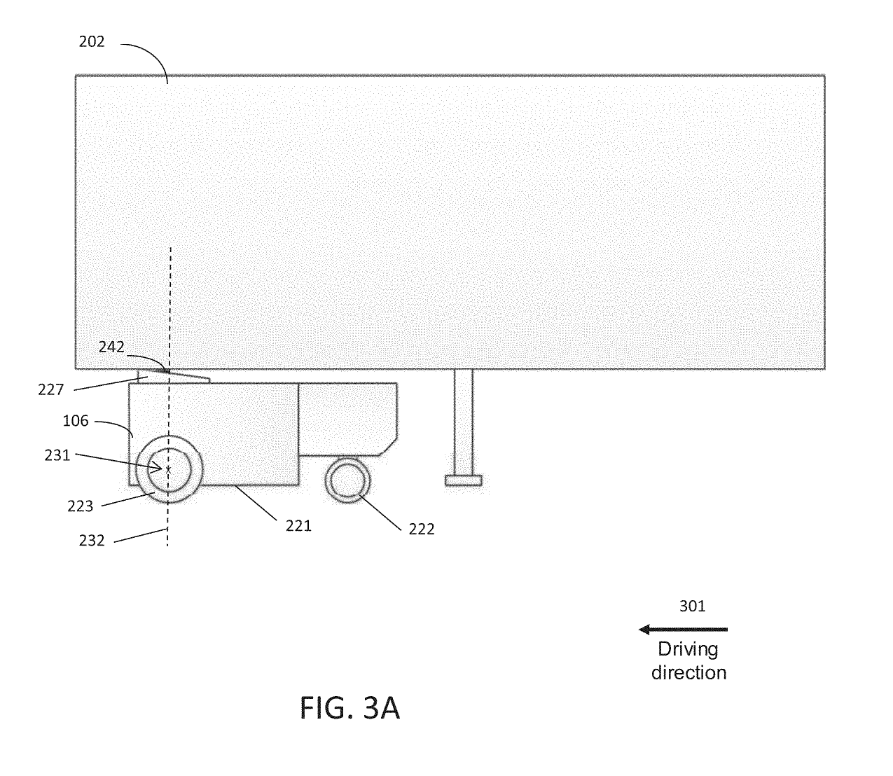

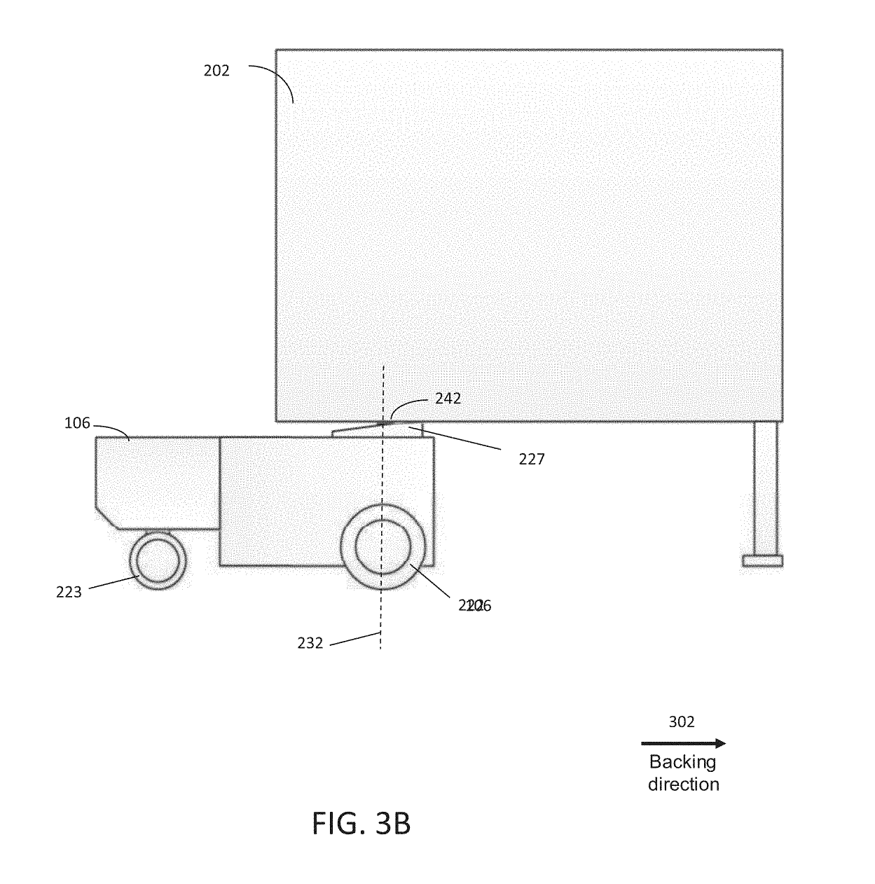

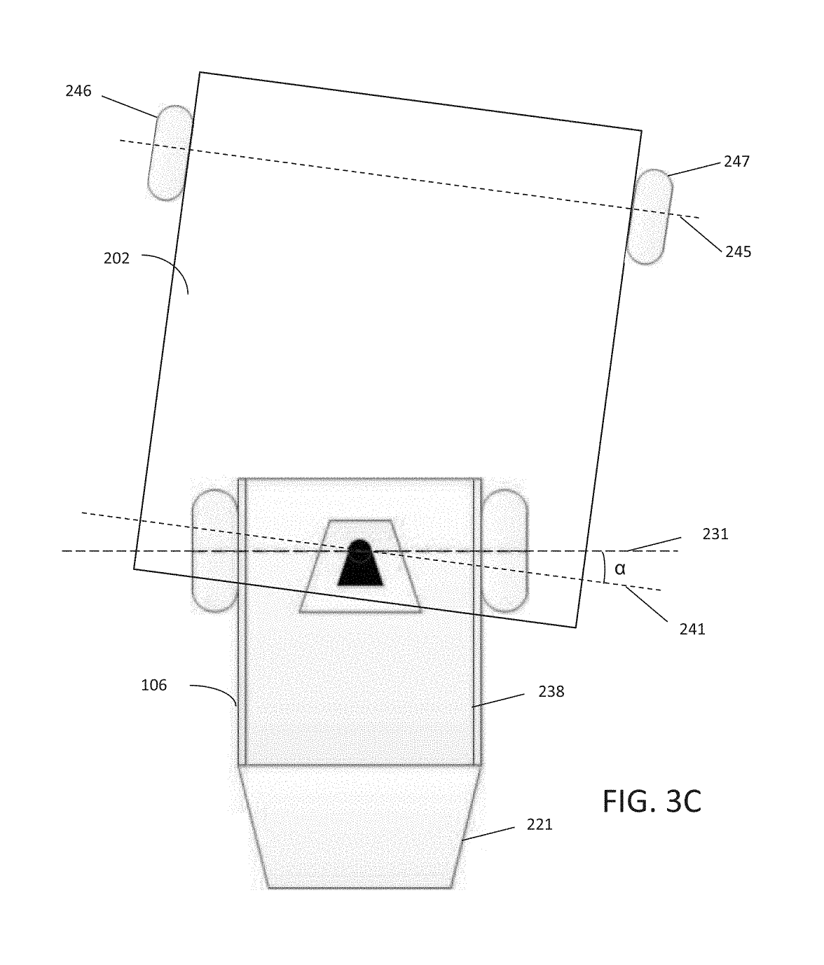

FIG. 2C illustrates a top view of the autonomous yard vehicle 106 in accordance with embodiments of the present disclosure. The first drive wheel 223 and the second drive wheel 224 are opposingly spaced from each other proximate to a proximal end 251 of the chassis 221 and aligned about a first axis of rotation 231. The autonomous yard vehicle 106 further includes a coupling 227 operatively coupled to the chassis 221. The coupling 227 has a female connector, such as a slot, configured to receive and mechanically couple with a male connector of a trailer, such as a kingpin. The trailer angle sensors 238 can be disposed in an array along one or both sides of the chassis 221. The trailer angle sensors 238 can be used to identify the angle between the autonomous yard vehicle 106 and a trailer to be coupled or already coupled with the autonomous yard vehicle 106. The coupling between the autonomous yard vehicle system 106 and the trailer is described herein in more detail below with respect to FIGS. 3A-3C. As shown in FIG. 2C, the slot of the coupling 227 is aligned with and vertically offset from the first axis of rotation 231.

FIGS. 2D and 2E illustrate a bottom view and a side view, respectively, of the autonomous yard vehicle 106 according to various embodiments of the present disclosure. The autonomous yard vehicle 106 includes at least one freely rotating wheel 222 disposed proximate to a distal end 252 of the chassis 221. For example, the freely rotating wheel 222 can be a caster disposed on the chassis 221 and supporting the autonomous vehicle. The caster includes a housing coupled to the autonomous yard vehicle 106, and a wheel rotatable coupled to the housing.

FIGS. 3A and 3B illustrate side view of the autonomous yard vehicle 106 that is coupled with a trailer 202 according to various embodiments of the present disclosure. As shown in FIG. 3A, the autonomous yard vehicle 106 is coupled with a trailer 202 and driving forward in the direction shown as the arrow 301, and in FIG. 3B the autonomous yard vehicle 106 is coupled with the trailer 202 and backing up in the direction shown as the arrow 302. Thus, the freely rotating wheel 222 trails the first and second drive wheels 223, 224 when the trailer 202 is being pulled or pushed. Therefore, the freely rotating wheel 222, i.e., the caster, can stabilize the autonomous vehicle and the coupled trailer when the vehicle is driving.

In one embodiment, when a trailer in the distribution center needs to be moved to a particular location, such as a door or a dock, an instruction to move the trailer can be sent to the computing device 230 coupled to the autonomous yard vehicle 106. In response to receiving the instruction, the computing device 230 can generate a route of navigating the autonomous yard vehicle 106 to the location of the trailer 202 according to a map of the distribution center indicating the locations of the autonomous yard vehicle 106 and the trailer 202. The route is also generated according to detection results from the sensors which indicate objects around the autonomous yard vehicle 106. In some embodiments the computing device can implement a simultaneous localization and mapping (SLAM) algorithm to generate a map of the environment and to maintain a location of the autonomous yard vehicle in the environment.

When the autonomous yard vehicle 106 is located in a proximity to the trailer, the autonomous yard vehicle 106 identifies whether the trailer is the correct trailer that needs to be coupled according to the instruction. The autonomous vehicle can identify the trailer by reading a barcode associated with the trailer using a barcode reader, extracting text from an image including a trailer number using an image capture device, and reading an RFID affixed to the trailer using a RFID reader, etc. If the trailer is the correct trailer, the computing device can guide the slot of the coupling 227 to receive the kingpin 242 of the trailer 202. The object avoidance sensors 232 can detect the position of the chassis 221 relative to the trailer 202. Based on the detected position, the autonomous yard vehicle 106 can compute a distance between the coupling 227 and the kingpin 242 using the detected position of the trailer, and can generate a route of moving the autonomous yard vehicle 106 to facilitate mechanical coupling between the slot of the coupling 227 and the kingpin 242.

After mechanically coupling the kingpin to the slot, the trailer 202 can be autonomously navigated by the autonomous yard vehicle system 106 to a dock or a door for unloading freight from the trailer or loading freight onto the trailer. The first and second drive wheels 223, 224 of the autonomous yard vehicle can be independently driven by the first and second motors 225, 226 to rotate or pivot the chassis 221 about a second axis of rotation 232 as shown in FIGS. 3A and 3B. The second axis of rotation 232 perpendicularly intersects the first axis of rotation 231, and the kingpin 242 extends along the second axis of rotation 232, where the first axis of rotation 231 and the second axis of rotation 242 reside in a common vertical plane (i.e. at an angle normal to the earth). Therefore, when the trailer is coupled with the autonomous yard vehicle, the kingpin of the trailer is aligned with and vertically offset from the first axis of rotation 231. Aligning the first and second axes of rotation 231, 232, respectively, as described herein advantageously enables the trailer coupled to the autonomous yard vehicle to have a smaller turning radius than when the axes are out of alignment, which can be beneficial in navigating tight and/or crowded environment

FIG. 3C illustrates a schematic diagram of top view of the autonomous yard vehicle 106 coupled with the trailer 202 according to various embodiments of the present disclosure. When the autonomous yard vehicle 106 coupled with the trailer 202 is driving, for example, moving straight or turning around other objects, the autonomous yard vehicle 106 can generate a route of travel based on the angle between the chassis 221 of the system 106 and the trailer 202, i.e., angle α in FIG. 3C.

Angle α, as shown in FIG. 3C, is formed by the first axis of rotation 231 of the vehicle 106 and direction 241 that is parallel with an axis of rotation 245 which the wheels 246, 247 of the trailer 202 are aligned about. Therefore, angle α represents the angle between the autonomous vehicle 106 and the trailer 202. The angle α between the autonomous yard vehicle 106 and the trailer 202 can be determined by the autonomous yard vehicle 106 based on the position of the chassis 221 relative to the trailer 202 detected by the trailer angle sensors 238. The trailer angle sensors 238 can be disposed along one or both sides of the chassis 221 and include infrared (IR) reflective-type sensors. The infrared (IR) sensors emit infrared beams vertically in a direction parallel to the second axis of rotation 232, such that based on the infrared beams reflected by the bottom of the trailer 202 and detected by the IR sensors, the angle of the chassis 221 relative to the trailer 202 can be determined. Based on this angle between the chassis and the trailer, the autonomous yard vehicle 106 can generate a route of travel when the kingpin 242 is mechanically coupled to the slot of the coupling 227 and/or can determine whether a current turning radius of the autonomous yard vehicle is unsafe at a given speed.

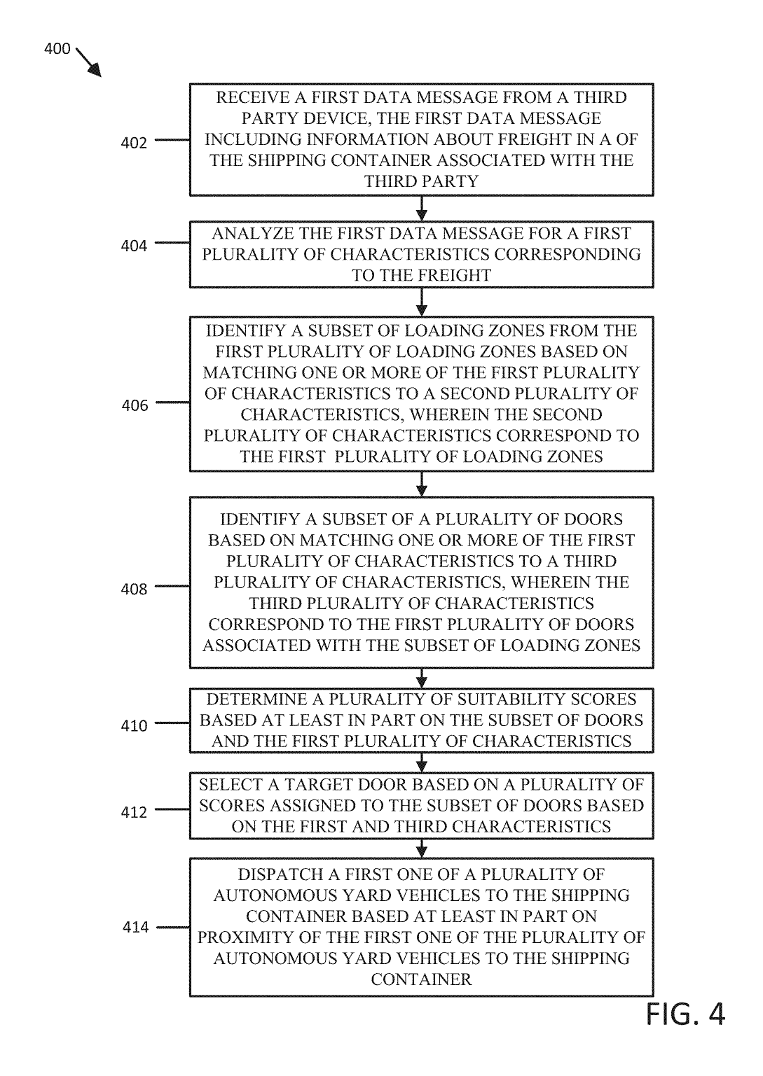

FIG. 4 is a flowchart illustrating and describing a process 400 of selecting a distribution center dock and dispatching an autonomous yard vehicle by the yard management system 112 according to an exemplary embodiment.

At step 402, a first data message is received by a server from a third party device. The first data message includes information about freight in a trailer associated with the third party. The first data message can be received by the server 104 in the form of an ASN from shipper. Alternatively, the first data message can be received by the server in the form as a database query containing information consistent with an ASN that a shipper may provide.

At step 404, the first data message is analyzed by the server for a first set of characteristics corresponding to the freight in the trailer. The first data message is analyzed for characteristics that indicate appropriate placement in the distribution center. That is, to indicate to which dock door the trailer should be moved. These characteristics may include whether the freight is tall, floor loaded or loose boxes, palletized, and within which module of the distribution center the freight is to be stored. As described herein, the first data message can be an ASN notification from the shipper and/or can be processed data derived from an ASN or similar transmission, which characterizes all the freight in the trailer. Optionally the trailer may be mapped based on the freight. Mapping can result in two different classifications: mixed or segregated, where segregated loads include distinct separation between the freight in the front and the freight in the back of the trailer. A mixed trailer classification defines a trailer that includes freight which does not have a clear split between types of freight within the trailer. Mapping can be determined by the manifest included with an ASN. Items can be added to the manifest as they are loaded into the trailer by the supplier or party loading the fright into the trailer, so the closer to the top of the manifest an item appears, the closer that item should be to the front of the trailer. For segregated loads, i.e. trailers with freight having the segregated classification, a separate determination of the most suitable door should be performed for each segregated freight load.

At step 406, a subset of loading zones from a first set of loading zones is identified by the server based on matching one or more of the characteristics in the first set of characteristics to characteristics in first set of loading zones. The loading zones can correspond to different modules within the distribution center. Zones may be identified by the freight that passes through them. For example, zones can correlate, but are not limited, to staple stock (SS), distribution assembly (DA), or non-conveyable (NC). Based on the zones, a percentage of the freight should be determined to be destined for that zone. For example, if 30% of a freight in a trailer is staple stock, that portion of freight is destined for the zone corresponding to staple stock.

At step 408, a subset of doors are identified by the server based on matching one or more of the characteristics in the first set of characteristics to characteristics corresponding to a first set of doors associated with the subset of loading zones. Further, doors within particular zones can have varying characteristics to better facilitate different loads. For example, some doors are taller to handle taller loads. Dock levelers can be available at specific doors. Extenders can be available for unloading only at certain doors as well. Based on the freight, and similar to the zones above, the freight is proportioned based on the necessity of these facilities at the doors. For example, if 30% of the freight in a trailer requires an extender, that portion of the freight is accounted for in the identifying of the first set of characteristics and the first set of doors and used in the calculation of a suitability score.

At step 410, suitability scores for a door-trailer pair are determined by the server based at least in part on the subset of doors and the first set of characteristics. Suitability scores can be determined utilizing a point system. As one example, in one implementation, a maximum 30 points can be spread across the following categories corresponding to zones and characteristics: 10 points for a dock, 5 points to selecting a door height (1 point threshold), 5 points to selecting a dock leveler (1 point threshold), 5 points allocated to selecting equipment (extendable, 3.75 point threshold), and 5 points for selecting location or zone.

Each of the characteristics are weighted and computed based on the freight contained in a trailer to be assigned to a door.

The dock portion of the suitability score can be represented by equation 1:

10 points*% of trailer requiring dock Equation 1

The door height (“Door Height”) portion of the suitability score can be conditional so as to meet a threshold as demonstrated in equation 2:

5 points*% of trailer needing tall door IF (5 points*% of trailer needing to door)≥1 point Equation 2

The dock leveler portion (“Dock”) of the suitability score can be conditional so as to meet a threshold as demonstrated in equation 3:

5 points*% of trailer needing dock leveler IF (5 points*% of trailer needing dock leveler)≥1 point Equation 3

The equipment portion of the suitability score can be conditional so as to meet a threshold. As demonstrated in equation 4, the equipment portion (“Equipment”) can be determined based on the non-palletized portion of the freight:

5 points*% of trailer palletized IF DOOR.Extendable=No; else5 points*% trailer floor loaded Equation 4

The location portion (“Location”) may be represented by equation 5:

Σ_{z}5*% of trailer in zones z*(1−0.1(|A−z|) Equation 5

The total door score may be calculated by equation 6:

Dock+Door height+Equipment+Location Equation 6

Based on the equations 1-6, a sample delivery is demonstrated below. In this non-limiting demonstrative example, a trailer can have the following freight attributes: 23% DA floor, 40% SS B module, 27% SS D module, and 10% NC tall door, 0% requiring dock leveler. In this example, there are 7 doors. The first door has the following characteristics: door on NC dock with no extendable. The second door has the following characteristics: door in A module with no extendable. The third door has the following characteristics: door in B module with no extendable. The fourth door has the following characteristics: door in C module with no extendable. The fifth door has the following characteristics: door in D module with no extendable. The sixth door has the following characteristics: door in E module with no extendable. The seventh door has the following characteristics: door on DA dock with no extendable. Table 1, below shows the evaluation of location component of the suitability score based on Equation 4.

TABLE 1

| | NC Dock | A Zone | B Zone | C Zone | D Zone | E Zone | DA Dock |
|---|---|---|---|---|---|---|---|
| 10% NC | 0.5 | 0.45 | 0.4 | 0.35 | 0.3 | 0.25 | 0.2 |
| 40% SS B | 1.6 | 1.8 | 2.0 | 1.8 | 1.6 | 1.4 | 1.2 |
| 27% SS D | 0.81 | 0.945 | 1.08 | 1.215 | 1.35 | 1.215 | 1.08 |
| 23% DA | 0.46 | 0.575 | 0.69 | 0.805 | 0.92 | 1.035 | 1.15 |
| haul* | 0 | 0 | 0 | 0 | 0 | 0 | 1.15 |
| DA no | | | | | | | |
| haul* | | | | | | | |
| Total | 3.37 | 3.77 | 4.17 | 4.17 | 4.17 | 3.9 | 3.63 |
| haul* | 2.91 | 3.195 | 3.48 | 3.365 | 3.25 | 2.865 | 3.63 |
| Total no | | | | | | | |
| haul* | | | | | | | |

The door component of the sample delivery would be consistent with Table 2. Table 2 incorporates equations 1-4, and 6. The results of the location scoring from Table 1 are recreated in Table 2 for simplicity.

TABLE 2

| | Door 1 | Door 2 | Door 3 | Door 4 | Door 5 | Door 6 | Door 7 |
|---|---|---|---|---|---|---|---|
| Dock score | 10 * 10% = 1 | 10 * 67% = | 10 * 67% = | 10 * 67% = | 10 * 67% = | 10 * 67% = | 10 * 23% = |
| (10 points) | | 6.7 | 6.7 | 6.7 | 6.7 | 6.7 | 2.3 |
| Door | 0 | 0 | 0 | 0 | 0 | 0 | 0 |
| height | | | | | | | |
| score (5 | | | | | | | |
| points) | | | | | | | |
| Dock | 0 | 0 | 0 | 0 | 0 | 0 | 0 |
| leveler | | | | | | | |
| score (5 | | | | | | | |
| points) | | | | | | | |
| Equipment | 5 * 77% = | 5 * 77% = | 5 * 77% = | 5 * 77% = | 5 * 77% = | 5 * 77% = | 5 * 77% = |
| score (5 | 3.85 | 3.85 | 3.85 | 3.85 | 3.85 | 3.85 | 3.85 |
| points) | | | | | | | |
| Location | 3.37 | 3.77 | 4.17 | 4.17 | 4.17 | 3.9 | 3.63 |
| Score | | | | | | | |
| (from | | | | | | | |
| table | | | | | | | |
| above) | | | | | | | |
| Total | 8.22 | 14.32 | 14.72 | 14.72 | 14.72 | 14.45 | 9.78 |

At step 412, a target door for the selected trailer is selected by the server based on a plurality of scores assigned to the subset of doors based on the characteristics of the freight in the trailer and the characteristics of the doors. In the above example, the target door to be selected can be one of doors 3, 4, or 5.

At step 414, a first one of the autonomous yard vehicles is dispatch to the trailer based at least in part on the proximity of the first one of the autonomous yard vehicles to the trailer and/or a current availability of the first one of the autonomous yard vehicles. The dispatched autonomous yard vehicle can locate the trailer in the yard using a location of the trailer provided by the server and the navigation system of the autonomous yard vehicle. Once the dispatched autonomous yard vehicle navigates to the trailer and identifies the trailer as the correct trailer (e.g., based on a trailer number), the autonomous yard vehicle can mechanically couple to the trailer, and tow the trailer to the selected door based on a location of the door provided by the server. As described above, the first one of the plurality of autonomous yard vehicles includes a pair of opposing spaced wheels that are independently driven about a first axis of rotation, a coupling having a slot for receiving a kingpin of the trailer defining a second axis or rotation that intersects the first axis of rotation, the first one of the autonomous yard vehicles navigates to the trailer, mechanically couples the kingpin to the slot, autonomously transports the trailer to the target door, and disengages the slot from the kingpin

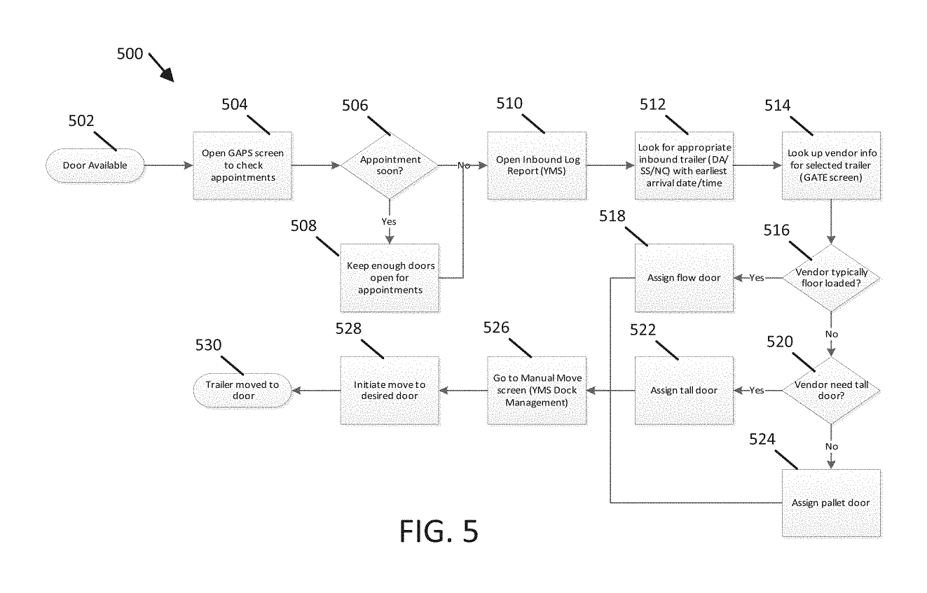

FIG. 5 is a flowchart illustrating an describing a process 500 of selecting a distribution center dock according to an exemplary embodiment

At step 502 a door becomes available. As a distribution center can be unloading trailer contents over time, a door can become available once the contents of a trailer at the door are removed from the trailer and stored in appropriate places in the distribution center, i.e. when the trailer is unloaded and transported to a parking spot away from the door.

At step 504, appointments are checked. In one embodiment, trailer appointments can be monitored through an application executing on a mobile device. Alternatively, an application can be executing on a terminal located in the distribution center. In another embodiment, the application can be integrated into the server 104 and appointments are checked autonomously, such that a door can be automatically reserved and assigned for a particular trailer at a particular time.

At step 506, any upcoming appointments are determined. A suitable quantity of doors are kept available for appointments at step 508 based on upcoming appointments for the doors. Appointments can receive priority in the yard management system. When scheduled in advance, trailers with appointments can be placed higher in a queue managed by the yard management system. As a result doors can be reserved for trailers with appointments. Alternatively, trailers can have appointments scheduled for particular doors and equipment, and thereby can have appropriate doors held open. An average time period for trailer processing can be utilized to determine whether a door will be available for an appointment. For example, in the instance where the average processing time for a trailer is 35 minutes and an appointment is scheduled for 15 minutes in the future, the availability of the door is held open for the appointment.

An inbound log report can be opened in the yard management system at step 510. The inbound log report can be the first recordation in the yard management system for the processing of a trailer and its contents at the distribution center. The inbound log report may include descriptions of the trailer, the contents, the vendor, and a time date stamp of the creation of the inbound log report.

At step 512, the yard management system searches for an appropriate inbound trailer with earliest arrival dates and times. The yard management system can process the trailers on a first in first out basis (FIFO) with the option for appointments. Barring preemption by appointment, the trailers can be processed based on their time of arrival at the distribution center.

At step 514, the yard management system can look up vendor information for a selected trailer to be assigned to a target door. The vendor information can include information relating to historical packaging of contents on the trailer, as well as equipment required to properly and safely unload the contents. Alternatively, the vendor information can be provided in the ASN. Upon the retrieval of the vendor information, a series of decisions based on the packaging of contents can be processed.

At step 516, the packaging of contents by vendor are determined include a high percentage of typically floor loaded content. If there is a high percentage of typically floor loaded content in the trailer, the trailer is assigned to a flow door at step 518. Alternatively, the yard management system can apply a score corresponding to the percentage of floor loaded content to the trailer.

At step 520, the packaging of contents by vendor are determined to include a high percentage of content that requirements of a tall door. If there is a high percentage of content requiring a tall door in the trailer, the trailer is assigned to a tall door at step 522. Alternatively, the yard management system can apply a score corresponding to the percentage of tall content to the trailer.

If the packaging of contents is determined to not include either a high percentage of floor loaded or tall content, the trailer is assigned to a pallet door at step 524. Alternatively, the yard management system can apply a score corresponding to the percentage of palletized content to the trailer.

After door assignments are completed, a manual move screen generated by the yard management system application is selected at step 526. The manual move screen allows a user to select the trailer to be moved as well as the available doors. Alternatively, the yard management system can utilize any scores determined in the prior steps to autonomously determine an appropriate door for the selected trailer.

At step 528, a move to the desired door can be initiated. In one embodiment, this can include utilizing the server 104 communicating with the one or more autonomous yard vehicles 106A, 106B, 106C shown in FIG. 1 to be deployed to the trailer, and attaching to the trailer. At step 530, the trailer can be moved to the desired/target door. The one or more autonomous yard vehicles 106A, 106B, 106C then navigate the yard with the trailer in tow, bringing the trailer to the desired door.

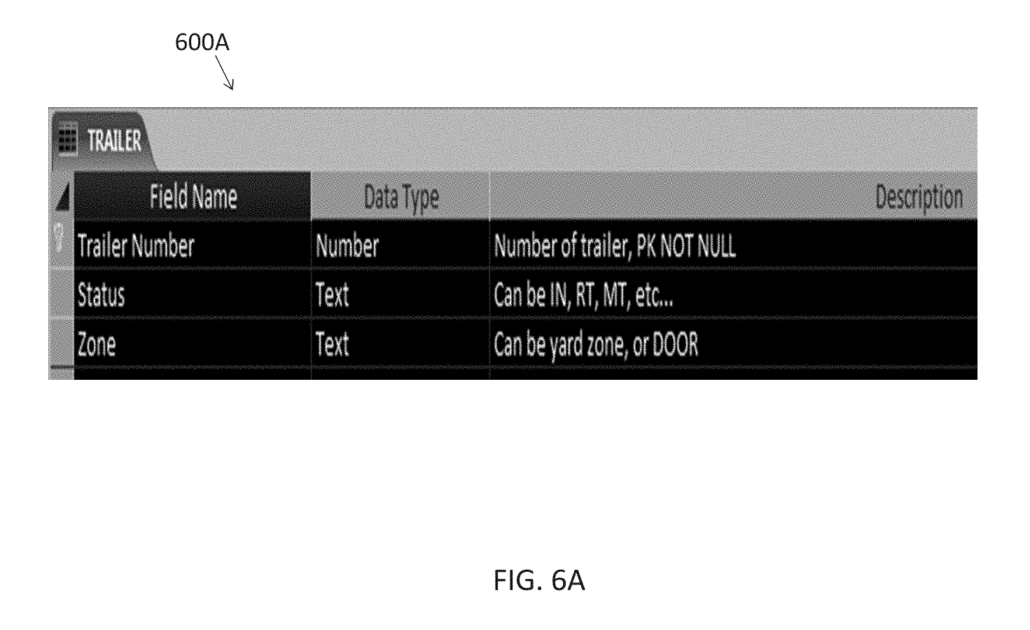

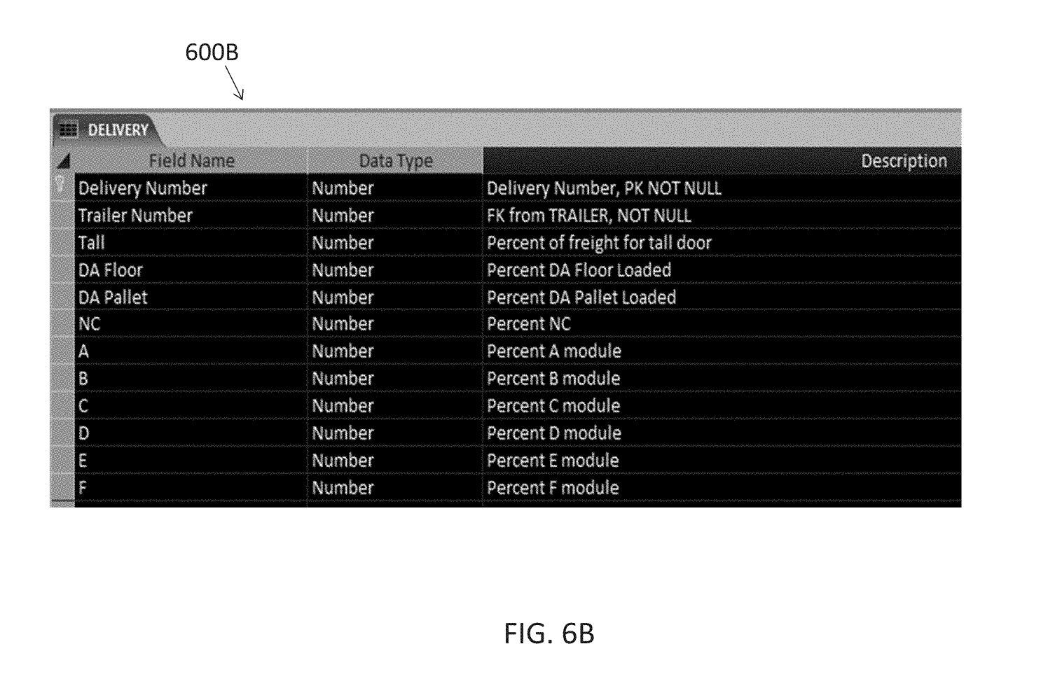

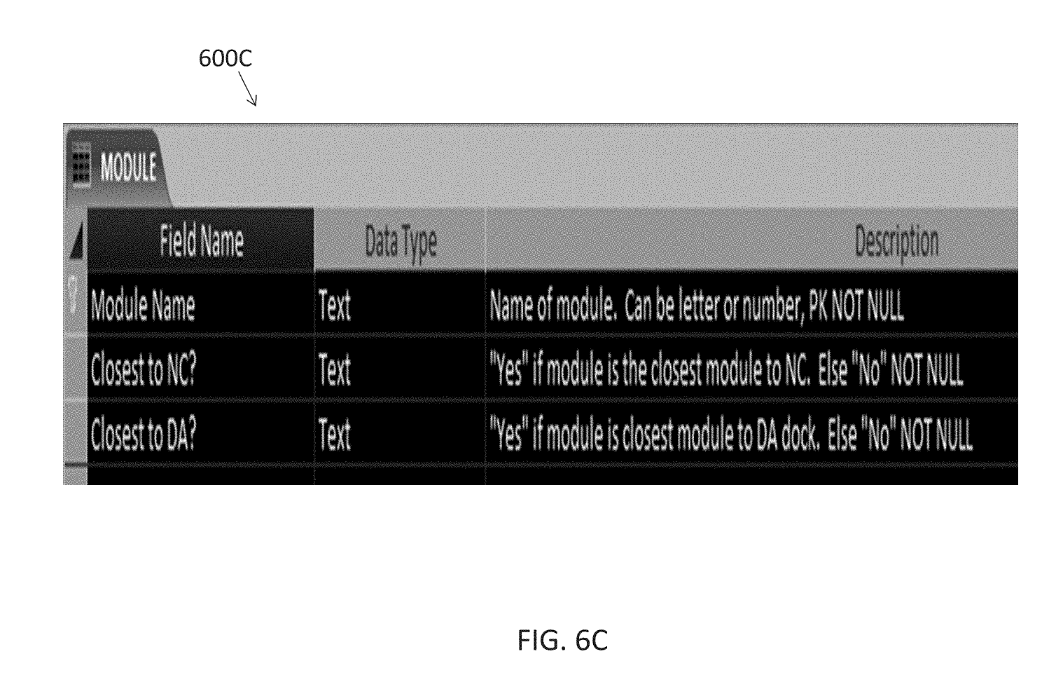

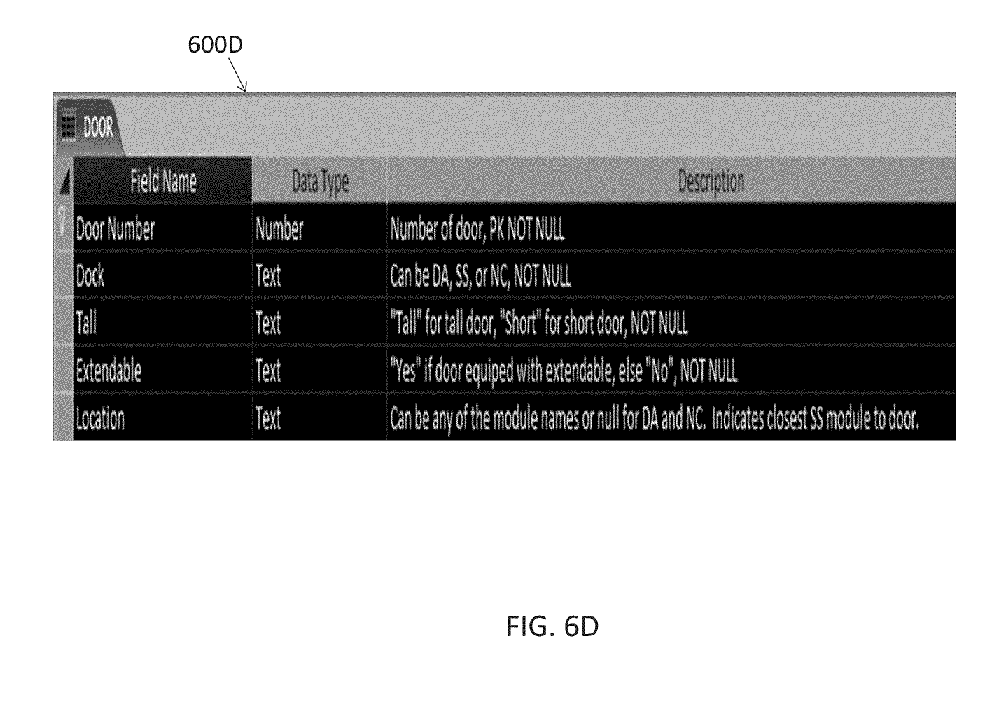

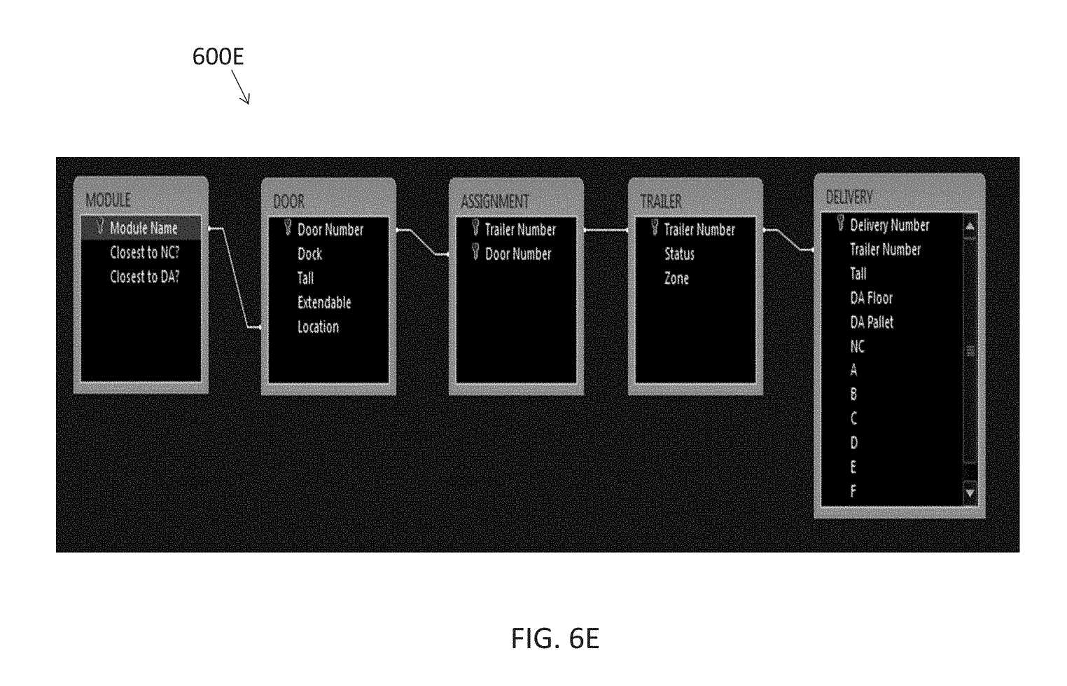

FIG. 6A is a table 600A illustrating a database format describing a trailer according to an exemplary embodiment. The database includes fields and values to identify a specific trailer as well as information related to the trailer such as status and zone. Status may include inbound, ret tag as well as other statuses. Zone can correspond to a zone in the yard and can also be DOOR if the trailer is at a door.

FIG. 6B is a table 600B illustrating a database format describing a delivery to a distribution center according to an exemplary embodiment. The database format includes fields describing the contents of a particularly delivery. Included are identifiers such as delivery number and trailer numbers. Other characteristics may be denoted including percentages of the various types of content in the trailer. Delivery number can be a manifest number. A trailer number may be a foreign key from the table 600A corresponding to trailers and maintaining a one to one relationship.

FIG. 6C is a table 600C illustrating a database format describing a module according to an exemplary embodiment. The database format includes fields describing modules which correspond to particularly layouts or areas within the distribution center.

FIG. 6D is a table 600D illustrating a database format describing a door according to an exemplary embodiment. The database format includes fields describing characteristics of door in the distribution center. Characteristics may include dock type, tall or short, extendable, and location.

FIG. 6E is a table 600E illustrating a relationship between the database format supporting the matching of a delivery to a distribution center door according to an exemplary embodiment. The database format shows the relationship between each of the above described database formats. Delivery database objects are related to trailer database objects. Trailers database objects are related to assignment database objects. Assignment database objects map to door objects. A module database object is a composition of door database objects.

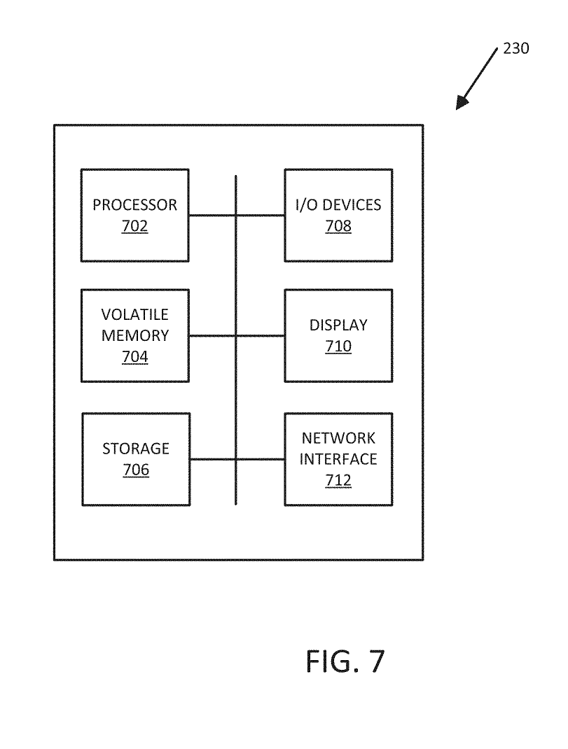

FIG. 7A is a block diagram illustrating an exemplary computing device suitable for use in an exemplary embodiment. Computing device 230 can execute the mobile application. The computing device 230 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives, one or more solid state disks), and the like. For example, volatile memory 704 included in the computing device 230 can store computer-readable and computer-executable instructions or software (e.g., mobile applications) for implementing exemplary operations of the computing device 230. The computing device 230 also includes configurable and/or programmable processor 702 for executing computer-readable and computer-executable instructions or software stored in the volatile memory 704 and other programs for implementing exemplary embodiments of the present disclosure. Processor 702 can be a single core processor or a multiple core processor. Processor 702 can be configured to execute one or more of the instructions described in connection with computing device 230.

Volatile memory 704 can include a computer system memory or random access memory, such as DRAM, SRAM, EDO RAM, and the like. Volatile memory 704 can include other types of memory as well, or combinations thereof.

A user can interact with the computing device 230 through a display 710, such as a computer monitor, which can display one or more graphical user interfaces supplemented by I/O devices 708, which can include a multi-touch interface, a pointing device, an image capturing device and a reader.

The computing device 230 can also include storage 706, such as a hard-drive, CD-ROM, or other computer-readable media, for storing data and computer-readable instructions and/or software that implement exemplary embodiments of the present disclosure (e.g., applications). For example, storage 706 can include one or more databases 110A, 110B for storing information associated with trailer information and autonomous yard vehicle location and can be indexed accordingly. The databases 110A, 110B can be updated manually or automatically at any suitable time to add, delete, and/or update one or more data items in the databases.

The computing device 230 can include a network interface 712 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 712 can include one or more antennas to facilitate wireless communication between the computing device 230 and a network and/or between the computing device 230 and other computing devices. The network interface 712 can include a built-in network adapter, network interface card, PCMCIA network card, card bus network adapter, wireless network adapter, USB network adapter, modem or any other device suitable for interfacing the computing device 230 to any type of network capable of communication and performing the operations described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step. Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. A system implemented in a distribution center comprising:
a plurality of autonomous yard vehicles;
a database comprises information relating to a plurality of loading zones and a plurality of doors associated with the plurality of loading zones;
a server in communication with the database, the server executing an application executing to:
receive a first data message from a third party device the first data message including information about freight in a trailer associated with the third party;
analyze the first data message for a first plurality of characteristics corresponding to the freight;
identify a subset of loading zones from the plurality of loading zones based on matching one or more of the first plurality of characteristics to a second plurality of characteristics, wherein the second plurality of characteristics correspond to the plurality of loading zones;
identify a subset of a plurality of doors based on matching one or more of the first plurality of characteristics to a third plurality of characteristics, wherein the third plurality of characteristics correspond to the plurality of doors associated with the subset of loading zones;
select a target door based on a plurality of scores assigned to the subset of doors based on the first and third characteristics; and
dispatch a first one of a plurality of autonomous yard vehicles to the trailer based at least in part on proximity of the first one of the plurality of autonomous yard vehicles to the trailer,
wherein the first one of the plurality of autonomous yard vehicles includes a pair of opposing spaced wheels that are independently driven about a first axis of rotation, a coupling having a slot for receiving a kingpin of the trailer defining a second axis or rotation that intersects the first axis of rotation, the first one of the autonomous yard vehicles navigates to the trailer, mechanically couples the kingpin to the slot, autonomously transports the trailer to the target door, and disengages the slot from the kingpin.

2. The system of claim 1, wherein the instructions that when executed cause the server to select a target door comprises:
assign point weight allocations to each of the third plurality of characteristics indicative of suitability of the second plurality of doors to the first plurality;
derive a plurality of factors by applying point weight allocation to the third plurality of characteristics augmented by the first plurality of characteristics; and
derive the plurality of scores by summing the plurality of factors;

3. The system of claim 1, wherein the first plurality of characteristics comprises palletized loads, floor loaded loads, number of items, and location of items in the trailer.

4. The system of claim 1, wherein the third plurality of characteristics comprise numeric identifiers, short doors, tall doors, dock levelers, and extendable conveyor associated with the first plurality of doors associated with the first plurality of loading zones.

5. The system of claim 1, wherein the second plurality of characteristics comprise staple stock, distributable assembly, and non-conveyable zones.

6. The system of claim 1, wherein the first data message is an advance ship notice.

7. The system of claim 1, wherein the subset of the plurality of doors comprises the subset of doors reduced by doors scheduled by appointment.

8. A non-transitory computer readable medium, having stored thereon, instructions that when executed by a computing device, cause the computing device to perform operations comprising:
receive a first data message from a third party device, the first data message including information about freight in a trailer associated with the third party;
analyze the first data message for a first plurality of characteristics corresponding to the freight;
identify a subset of loading zones from the plurality of loading zones based on matching one or more of the first plurality of characteristics to a second plurality of characteristics, wherein the second plurality of characteristics correspond to the plurality of loading zones;
identify a subset of a plurality of doors based on matching one or more of the first plurality of characteristics to a third plurality of characteristics, wherein the third plurality of characteristics correspond to the plurality of doors associated with the subset of loading zones;
select a target door based on the a plurality of scores assigned to the subset of doors based on the first and third characteristics; and
dispatch a first one of a plurality of autonomous yard vehicles to the trailer based at least in part on proximity of the first one of the plurality of autonomous yard vehicles to the trailer,
wherein the first one of the plurality of autonomous yard vehicles includes a pair of opposing spaced wheels that are independently driven about a first axis of rotation, a coupling having a slot for receiving a kingpin of the trailer defining a second axis or rotation that intersects the first axis of rotation, the first one of the autonomous yard vehicles navigates to the trailer, mechanically couples the kingpin to the slot, autonomously transports the trailer to the target door, and disengages the slot from the kingpin.

9. The computer readable medium of claim 8, wherein the instructions that when executed cause the server to select a target door comprises:
assign point weight allocations to each of the third plurality of characteristics indicative of suitability of the second plurality of doors to the first plurality of loading zones;
derive a plurality of factors by applying point weight allocation to the third plurality of characteristics augmented by the first plurality of characteristics; and
derive the plurality of scores by summing the factors;

10. The computer readable medium of claim 8, wherein the first plurality of characteristics comprises palletized loads, floor loaded loads, number of items, and location of items in the trailer.

11. The computer readable medium of claim 8, wherein the third plurality of characteristics comprise numeric identifiers, short doors, tall doors, dock levelers, and extendable conveyor associated with the first plurality of doors associated with the first plurality of loading zones.

12. The computer readable medium of claim 8, wherein the second plurality of characteristics comprise staple stock, distributable assembly, and non-conveyable zones.

13. The computer readable medium of claim 8, wherein the first data message is an advance ship notice.

14. The computer readable medium of claim 8, wherein the subset of the plurality of doors comprises the subset of doors reduced by doors scheduled by appointment.

15. A method comprising:
receiving a first data message from a third party device, the first data message including information about fright in a of the trailer associated with the third party;
analyzing the first data message for a first plurality of characteristics corresponding to the freight;
identifying a subset of loading zones from the first plurality of loading zones based on matching one or more of the first plurality of characteristics to a second plurality of characteristics, wherein the second plurality of characteristics correspond to the first plurality of loading zones;
identifying a subset of a plurality of doors based on matching one or more of the first plurality of characteristics to a third plurality of characteristics, wherein the third plurality of characteristics correspond to the first plurality of doors associated with the subset of loading zones;
determining a plurality of suitability scores based at least in part on the subset of doors and the first plurality of characteristics;
selecting a target door based on a plurality of scores assigned to the subset of doors based on the first and third characteristics; and
dispatching a first one of a plurality of autonomous yard vehicles to the trailer based at least in part on proximity of the first one of the plurality of autonomous yard vehicles to the trailer,
wherein the first one of the plurality of autonomous yard vehicles includes a pair of opposing spaced wheels that are independently driven about a first axis of rotation, a coupling having a slot for receiving a kingpin of the trailer defining a second axis or rotation that intersects the first axis of rotation, the first one of the autonomous yard vehicles navigates to the trailer, mechanically couples the kingpin to the slot, autonomously transports the trailer to the target door, and disengages the slot from the kingpin.

16. The method of claim 15, wherein selecting a target door comprises:
assigning point weight allocations to each of the third plurality of characteristics indicative of suitability of the second plurality of doors to the first plurality;
deriving a plurality of factors by applying point weight allocation to the third plurality of characteristics augmented by the first plurality of characteristics; and
deriving the plurality of scores by summing the factors;

17. The method of claim 15, wherein the first plurality of characteristics comprises palletized loads, floor loaded loads, number of items, and location of items in the trailer.

18. The method of claim 15, wherein the third plurality of characteristics comprise numeric identifiers, short doors, tall doors, dock levelers, and extendable conveyor associated with the first plurality of doors associated with the first plurality of loading zones.

19. The method of claim 15, wherein the second plurality of characteristics comprise staple stock, distributable assembly, and non-conveyable zones.

20. The method of claim 15, wherein the subset of the plurality of doors comprises the subset of doors reduced by doors scheduled by appointment.
